(19) United States
(12) Patent Application Publication
(10) Pub. No.: US 2003/0185640 A1
(43) Pub. Date: Oct. 2, 2003

(54) Multiple rake drill bits

(76) Inventor: Eiji Ito, Foothill Ranch, CA (US)

Correspondence Address: William L. Chapin, Law Offices of William L. Chapin, 16791 Sea Witch Lane, Huntington Beach, CA, 92649, US

(21) Appl. No.: 10/108,540

(22) Filed: Mar. 27, 2002

(51) Int. Cl. B23B 51/02

(52) U.S. Cl. 408/230

(57) ABSTRACT

A dual rake twist drill bit for drilling holes in articles made of abrasive materials, such as fiberglass-filled printed circuit boards, which relatively quickly dull bits, has a conical point and a short front cutting portion in which is formed spiraled flutes having cutting lips which are inclined to the axis of the bit at a relatively small helix angle or rake in the range of about 3 degrees to 10 degrees, and a longer rear portion in which the flutes and cutting lips have a larger rake of about 33 degrees. The dual rake bit has substantially greater wear resistance than single rake bits. In a modification of the dual rake bit, the central web portion thereof has a front longitudinal portion which is relatively acutely tapered, and a rear portion which is relatively modestly tapered, the dual tapered construction increasing resistance of the bit to breaking.

### BACKGROUND OF THE INVENTION

A. Field of the Invention The present invention relates to twist drill bits of the type used for drilling holes in articles such as printed circuit boards. More particularly, the invention relates to a novel twist drill bit construction in which the cutting flutes have at least two different rakes or helix angles, thus affording wear characteristics superior to those achievable with conventional, single rake drill bits.

B. Description of Background Art

Cutting tools used to work hard or refractory materials have a relatively short life. Also, tools such as drill bits used in drilling or forming composites containing boron or carbon fibers used in the aircraft industry, as well as in other industries requiring high-strength, light-weight materials, experience rapid wear. Even the drilling of aluminum alloy engine blocks rapidly wears out steel drill bits.

To increase the wear resistance and life of steel twist drill bits used in applications of the type described above, as well as in the fabrication of articles such as fiberglass impregnated epoxy printed circuit boards, cutting portions of the bits are often fabricated from a very hard substance such as tungsten carbide. However, even tungsten carbide is abraded fairly rapidly by abrasive work pieces such as printed circuit boards containing glass fibers. Thus, carbide bits must be periodically re-sharpened or re-pointed to maintain hole tolerances, although less frequently than steel bits. Therefore, even though tungsten carbide drill bits last longer than all-steel bits, downtimes associated with re-sharpening and replacing carbide drill bits is still a problem.

Solutions to the problem of further increasing the life of drill bits used to work refractory materials were disclosed in U.S. Pat. No. 5,443,337, issued August 1995, U.S. Pat. No. 5,611,251, issued March 1999, and U.S. Pat. No. 6,029,544, issued Feb. 29, 2000, all to Katayama. The foregoing patents for Sintered Diamond Drill Bits And Method Of Making disclosed drill bits for cutting hard and abrasive materials which have cutting tips formed from sintered polycrystalline diamond (PCD) or poly crystalline cubic boron nitride (PCBN) contained in one or more inserts installed in a drill bit blank, near the tip thereof. The present invention was conceived of to provide longer wearing twist drill bits for use with refractory materials such as printed circuit boards, in which the small size of the bits would make fabrication of the drill body as a composite structure, rather than a single piece structure, impractical.

### OBJECTS OF THE INVENTION

An object of the present invention is to provide a twist drill bit which has improved wear resistance properties.

Another object of the invention is to provide a twist drill bit which is less susceptible to undesired radial deflection or wander during drilling, thus providing increased accuracy in positioning the exit opening of holes drilled through articles.

Another object of the invention is to provide a twist drill bit which has a unitary drill body, improved wear resistance, and reduced tip wander.

Another object of the invention is to provide a twist drill bit in which cutting lips thereof have at least two different rakes or helix angles.

Another object of the invention is to provide a multiple rake twist drill bit which has a unitary drill body provided with cutting lips that have a first, front longitudinal cutting portion extending a short distance rearward of the tip of the drill at a first helix angle or rake, and a second, longer cutting portion which extends rearwardly from the front cutting portion and has a larger helix angle or rake.

Another object of the invention is to provide a unitary body twist drill bit which has a front cutting portion provided with cutting lips angled with respect to the longitudinal axis of the bit at a first helix angle or rake in the approximate range of 3 degrees to 15 degrees, and a second cutting portion rearward of the front cutting portion provided with cutting lips which have a second, larger helix angle or rake, in the approximate range of 15 degrees to 45 degrees.

Another object of the invention is to provide a multiple rake twist drill bit in which cutting lips thereof have a first front portion inclined at a first helix angle or rake, an intermediate longitudinal portion inclined at a second helix angle, and a rear longitudinal portion inclined at a third helix angle, which may be equal to the first helix angle.

Another object of the invention is to provide a twist drill bit in which different longitudinal portions of a central web thereof have different tapers.

Another object of the invention is to provide a multiple web taper twist drill bit in which a front longitudinal portion of a web thereof has a larger taper than a rear longitudinal portion of the web.

Various other objects and advantages of the present invention, and its most novel features, will become apparent to those skilled in the art by perusing the accompanying specification, drawings and claims.

It is to be understood that although the invention disclosed herein is fully capable of achieving the objects and providing the advantages described, the characteristics of the invention described herein are merely illustrative of the preferred embodiments. Accordingly, I do not intend that the scope of my exclusive rights and privileges in the invention be limited to details of the embodiments described. I do intend that equivalents, adaptations and modifications of the invention reasonably inferable from the description contained herein be included within the scope of the invention as defined by the appended claims.

### SUMMARY OF THE INVENTION

Briefly stated, the present invention comprehends an improved twist drill bit for drilling holes in articles such as printed circuit boards made of refractory materials such as fiberglass which tend to relatively quickly dull the cutting surfaces of the bit.

A dual rake embodiment of a multiple rake, improved twist drill bit according to the present invention has a conical point and a front fluted cutting portion rearward of the point in which cutting lips at the edges of the flutes have a first, relatively small helix angle or rake, typically in the range of 3 degrees to 15 degrees. The front, low-rake cutting portion of the twist drill bit has a relatively short length at least as long as the drill diameter, e.g., about 0.030 to 0.050 inch for a 0.015 inch diameter bit. Rearward of the low-rake front cutting portion, a twist drill bit according to the present invention has a rear fluted cutting portion with cutting lips which are angled at a larger, more conventional helix angle or rake of about 33 degrees relative to the longitudinal axis of the drill bit.

Improved, dual-rake twist drill bits according to the present invention have been found to afford substantially better wear characteristics than conventional, single-rake bits. For example, comparative flank wear land measurements on a dual rake drill bit according to the present invention and a conventional single rake drill bit of the same size indicate that the improved bit experiences less wear after drilling 4,000 holes than a conventional bit having drilled 1,000 holes. Moreover, tests have indicated that dual rake twist drill bits according to the present invention experience less hole wander than single rake bits.

Another embodiment of a multiple rake twist drill bit according to the present invention has a front longitudinal portion in which the cutting lips have a conventional rake, an intermediate, low rake portion, and a rear, conventional rake portion.

### BRIEF DESCRIPTION OF THE DRAWINGS

FIG. 1 is a side elevation view of a conventional, single-rake prior art twist drill bit.

FIG. 2 is a front end elevation view of the prior art bit of FIG. 1.

FIG. 3 is a fragmentary perspective view of a dual rake twist drill bit according to the present invention, on an enlarged scale.

FIG. 4 is a fragmentary side elevation view of the drill bit of FIG. 3, taken in the direction 4-4.

FIG. 5 is a view similar to that of FIG. 4, but showing the drill bit rotated ninety degrees counterclockwise around its longitudinal axis.

FIG. 6 is a front end elevation view of the drill bit of FIG. 3.

FIG. 7 is a fragmentary side elevation view of a second embodiment of a multiple rake twist drill bit according to the present invention, in which cutting flutes in an intermediate longitudinal portion thereof have a small rake.

FIG. 8 is a fragmentary view of the drill bit of FIG. 7, showing a rear portion of the drill bit.

FIG. 9 is a fragmentary side elevation view, on an enlarged scale, of a third embodiment of a dual rake twist drill bit according to the present invention, in which the body thereof is undercut.

FIG. 10 is a view similar to that of FIG. 9, but on a further enlarged scale and showing the drill bit rotated ninety degrees clockwise around its longitudinal axis.

FIG. 11 is a partly diagrammatic fragmentary side elevation view of a prior art twist drill bit which has a front tapered web and a back tapered cutting surface.

FIGS. 12A-12E are transverse sectional views of the drill bit of FIG. 11, taken at successively further distances rearward from the tip thereof.

FIG. 13 is a partly diagrammatic fragmentary side elevation view of a modification of a twist drill bit according to the present invention, in which the web thereof has multiple tapers.

### DESCRIPTION OF THE PREFERRED EMBODIMENTS

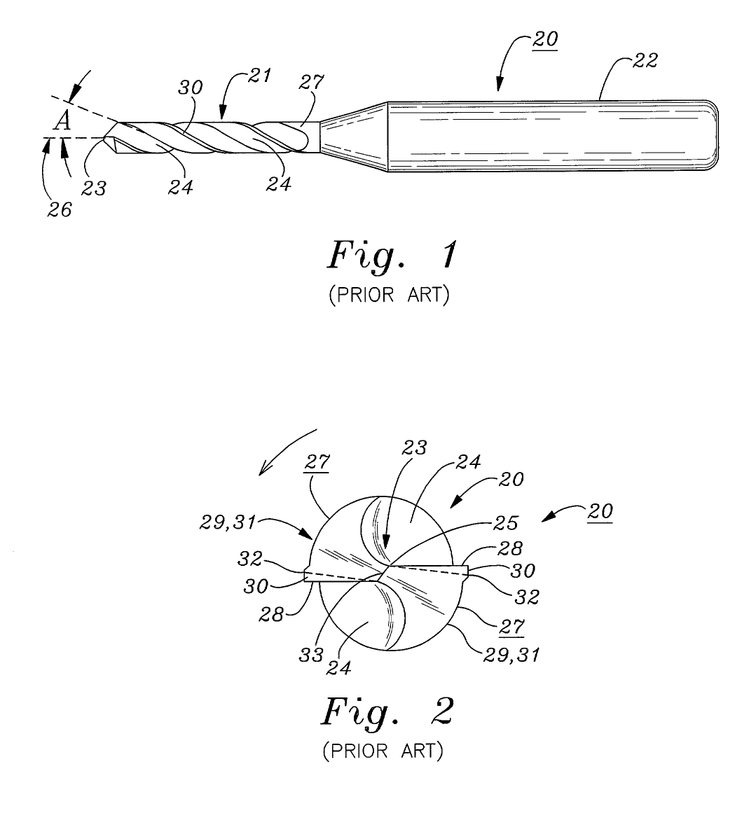

The novel and advantageous structure and functions of multiple rake twist drill bits according to the present invention may perhaps be best understood by reviewing briefly for comparison the structure of a typical prior-art, single-rake bit. Thus, as shown in FIGS. 1 and 2, a single rake twist bit 20 of prior art design includes an elongated, generally cylindrically-shaped front drill body 21 which protrudes coaxially forward from a cylindrically-shaped rear shank 22. For larger drill bit sizes, e.g., greater than ⅛ inch in diameter, body 21 and 22 may be formed of a single piece of steel or other hard material. However, small drill bits of the type used to drill holes in printed circuit boards (PCB's), typically have a ⅛ inch diameter steel shank, and a smaller diameter drill body, e.g., 1/64 inch or less. Moreover, small drill bits used in the PCB industry often have a composite construction, in which a small diameter, tungsten carbide drill body is inserted into a ⅛ inch diameter stainless steel shank, as shown in FIG. 1.

Referring now to FIG. 2 in addition to FIG. 1, it may be seen that body 21 of drill bit 20 has at the front end thereof a generally conically-shaped tip or point 23, and a pair of diametrically opposed, helically spiraled grooves or flutes 24 which are cut into the body and are disposed from tip 23 rearwardly towards shank 22. Flutes 24 penetrate deeply towards a central uncut region or web 25 of drill body 21, which is disposed along the longitudinal axis or center line 26 of the drill bit body. As shown in FIG. 1, flutes 24 are inclined at an angle A of between about 10 degrees and 45 degrees, typically about 35 degrees, with respect to longitudinal axis 26 of drill bit body 21.

In a customary manner of manufacturing a drill 20, drill body 21 is cut from a preform or blank having the shape of an elongated cylindrical rod. Portions of the cylindrical blank uncut by flutes 24 are referred to a lands 27. Referring to FIG. 2, rotation of drill bit 20 in a conventional clockwise or right-handed sense to bore a hole, as viewed forward from shank 22 to tip 23, appears as counter-clockwise rotation when viewed rearwardly from tip 23, as indicated by the curved arrow in FIG. 2. Thus, as shown in FIG. 2, a helically disposed cutting edge or lip 28 is formed on the counterclockwise edge of each land 27 adjacent each flute 24. Cutting lip 28 is inclined at a rake or helix angle with respect to longitudinal axis 26 of drill bit body 21, which is generally equivalent to flute angle A.

To reduce friction between lands 27 and the wall of hole being bored by bit 20, the outer cylindrical surface 29 of each land is relieved radially inwards of lip 28 over most of the circumferential width of the land to form a thin margin or rib 30. The radially inwardly relieved land surface is spaced inwards from the uncut outer cylindrical surface 32 of margin 30 at a distance referred to as rib clearance or body clearance. As is also shown in FIGS. 1 and 2, the two generally conically-shaped front end faces of lands 27 intersect at a dihedral angle which forms a chisel edge 33 at the vertex of tip 23. Body 21 of drill bit 20 is typically back tapered to a slightly smaller diameter from tip to shank, to further decrease friction between the drill body and a bore wall.

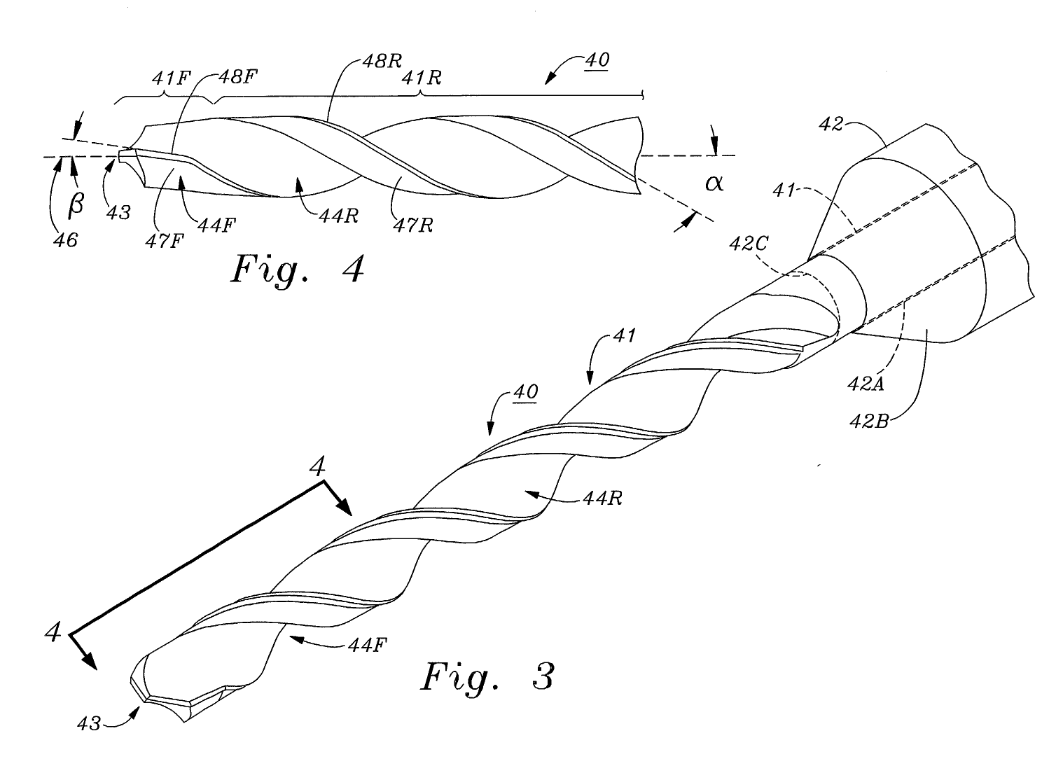

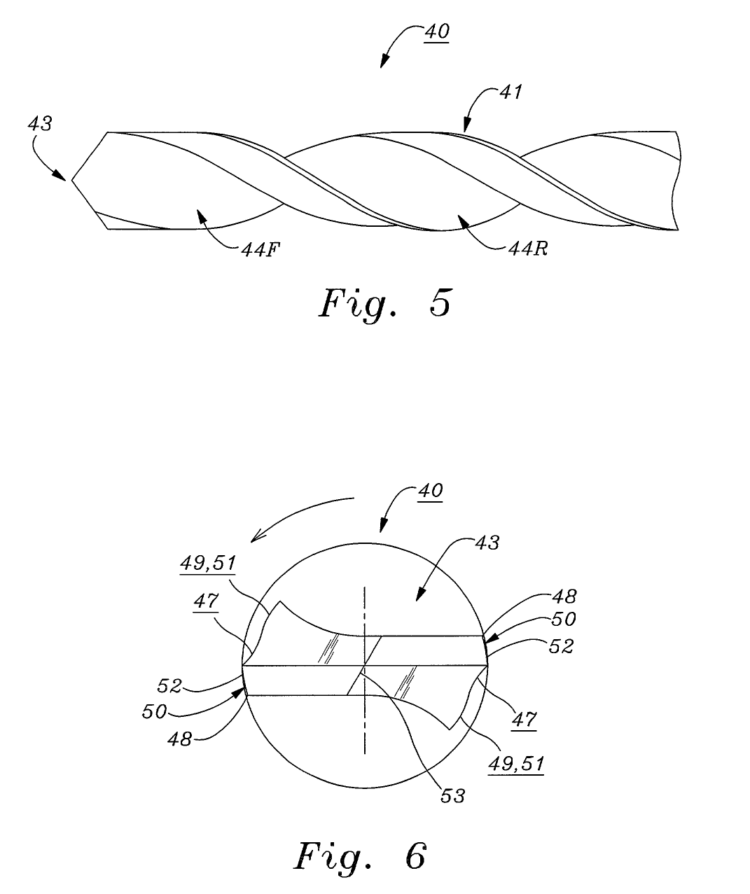

FIGS. 3-6 illustrate a basic, dual rake embodiment of a multiple rake or helix angle drill bit 40 according to the present invention.

Referring first to FIG. 3, dual rake drill bit 40 according to the present invention may be seen to include a longitudinally elongated drill body 41 which protrudes coaxially forward from a cylindrically-shaped shank 42. Shank 42 is insertable into a rotatably driven collet or chuck of a drilling machine (not shown). Body 41 of bit 40 may be of any convenient diameter and length suitable for drilling holes of a given diameter and depth. When sized for drilling small holes, in printed circuit boards, for example, drill 40 may have a stepped construction, in which drill bit body 41 is secured within a bore 42A disposed coaxially within a shank 42 having a larger diameter than the drill bit body, e.g., ⅛ inch. In this stepped diameter construction, larger diameter shank 42 preferably has a frustoconically-shaped front end face 42B which tapers forward to meet the smaller diameter drill bit body 41.

As shown in FIG. 4, body 41 of dual rake twist drill bit 40 has formed therein a plurality of helically spiraled grooves or flutes 44. In a preferred embodiment of dual rake bit 40, as shown in FIGS. 4 and 6, a pair of flutes 44 are provided, although different numbers of flutes may also be used. Portions of drill bit body 41 uncut by flutes 44 constitute a pair of helically spiraled lands 47.

As shown in FIG. 4, dual rake drill bit body 41 has at the front end thereof a tip or point 43 which has a generally conically-shaped profile. Flutes 44 are disposed rearwardly in helical spirals from tip 43 towards a rear terminus plane 42C located forward of shank transition section 42B.

As shown in FIGS. 3-6, a helically disposed cutting edge or lip 48 is formed on the counterclockwise edge of each land 47 adjacent each flute 44. To prevent excess friction between lands 47 and the wall of a hole being bored by bit 40, the outer cylindrical surface 49 of each land is relieved radially inwards of lip 48 over most of the circumferential width of the land to form a thin margin or rib 50. The radially inwardly relieved land surface 51 is spaced inwards from the uncut outer cylindrical surface 52 of margin 50 at a distance referred to as rib clearance or body clearance. As is also shown in FIGS. 3-5, the two generally conically-shaped front end faces of lands 47 intersect at a dihedral angle which forms a chisel edge 53 at the vertex of tip 43. Body 41 of drill bit 40 is preferably back tapered to a slightly smaller diameter from tip to shank to further decrease friction between the drill body and wall of a hole being drilled by the bit.

Referring again to FIG. 4, it may be seen that flutes 44, rather than being inclined at a constant rake or helix angle with respect to the longitudinal axis or center line 46 of drill bit body 41, are inclined at two different helix angles or rakes. Thus, drill bit body 41 of dual rake twist drill bit 40 has a relatively long rear portion 41R in which flutes 44R are inclined at a conventional helix angle or rake ∝ (Alpha) with respect to longitudinal axis 46, i.e., in the approximate range of 10 degrees to 45 degrees, with a preferred value of about 33 degrees, as shown in FIG. 4. However, body 41 of dual rake twist drill bit 40 also has a relatively short front portion 41F in which flutes 44F are inclined at a smaller helix angle or rake β (Beta) with respect to longitudinal axis 46 of the body. According to the present invention, flutes 44F in the front portion 41F of drill bit body 41 are inclined at an angle of about 3 degrees to 15 degrees with respect to longitudinal axis 46, with a preferred value of about 7.5 degrees. Although the exact length of front, low-rake fluted portion 41F of drill bit body 41 is not critical, that length is preferably greater than the diameter of the drill bit body, e.g., 0.030 to 0.050 inch for a drill bit having a diameter of 1/64 inch (0.015685 inch).

As shown in FIG. 4, tip 43 of dual rake bit 40 has a conventional point angle of about 118 degrees. As shown in FIG. 6, that conventional point angle, in combination with the substantially smaller rake or helix angle of the front portion 44F of flutes 44, results in tip 43 having a substantially different shape than that of a conventional, single rake drill bit tip 23, as shown in FIG. 2. Thus comparing FIG. 6 to FIG. 2, it may be seen that the transverse cross sectional area of lands 47 of dual rake bit 40 are substantially smaller relative to margins 50 and the outer diameter of the bit than that of ribs 27 of a conventional bit 20.

In comparing the performance of a sample drill bit 40 according to the present invention with that of a prior art drill bit of the same diameter and length, the following results were obtained.

As shown in dashed lines in FIG. 2, the front edges of each lip 28 of a twist drill bit 20 is worn circumferentially towards an adjacent land 27 by abrasion with material being cut to drill a hole, thus reducing the width of margins or ribs 30. The width of this wear is referred to as land flank wear, and when it reaches a predetermined value, the drill bit must be re-sharpened or re-pointed, to ensure that holes drilled with the bit meet nominal values of concentricity, circularity, straightness, as well as acceptably small values of gouging, surface roughness, and melting or smearing of holes drilled in workpieces made of composite materials such as glass-filled epoxies.

Comparison tests were made between a standard, prior art single-rake drill bit of the type shown in FIG. 2, and having a diameter of 0.0135 inch and a flute length of 0.215 inch, with a dual rake drill bit 40 having the same dimensions.

These tests indicated that dual-rake twist drill bit 40 according to the present invention could drill about four times as many holes as a prior art, single-rake drill, for the same amount of land flank wear. For example, a land flank wear of about 0.001 inch occurred in a prior art single rake bit after 1,000 holes were drilled, while the same amount of land flank wear did not occur in the dual rake bit until about 4,000 holes were drilled.

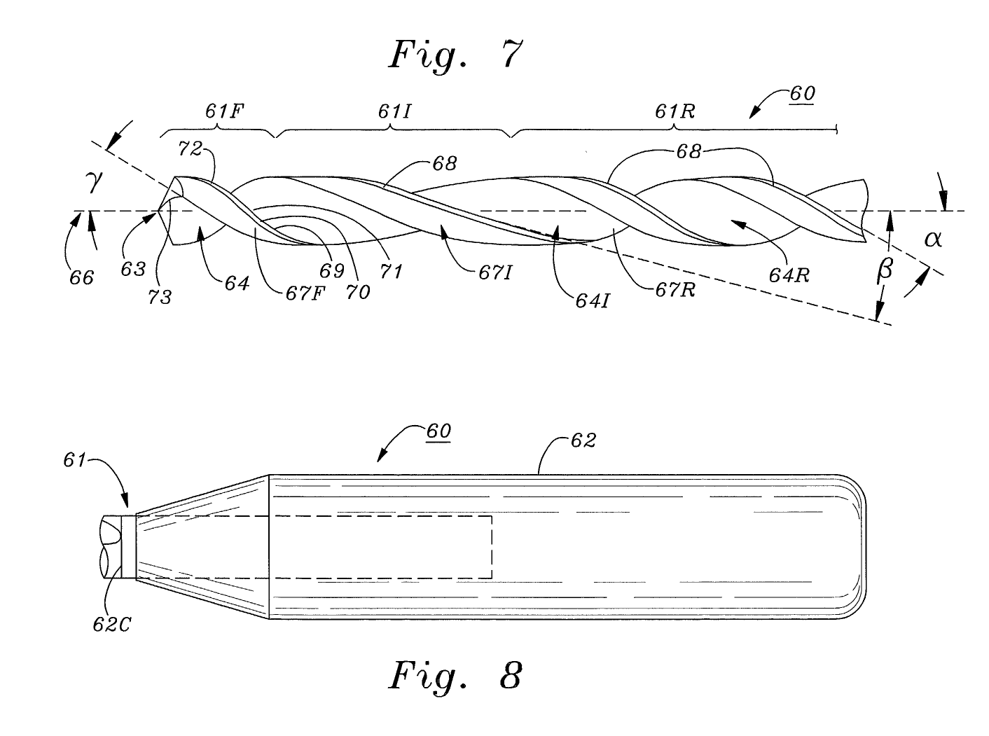

FIGS. 7 and 8 illustrate a second embodiment 60 of a multiple rake or helix angle twist drill bit according to the present invention.

Referring first to FIG. 7, it may be seen that embodiment 60 of a dual rake or helix angle twist drill bit has a longitudinally elongated drill bit body 61 which has formed therein a plurality of helically spiraled grooves or flutes 64. In the embodiment of a multiple rake drill bit 60 shown in FIGS. 7 and 8, a pair of flutes 64 are provided, although different numbers of flutes may also be used. Portions of drill bit body 61 uncut by flutes 64 constitute a pair of helically spiraled lands 67.

As shown in FIGS. 7 and 8, multiple rake drill bit body 61 has at the front end thereof a tip or point 63 which has a generally conically-shaped profile. Flutes 64 are disposed rearwardly in helical spirals from tip 63 towards a rear terminus plane 62C.

Referring still to FIGS. 7 and 8, a helically disposed cutting edge or lip 68 is formed on the counterclockwise edge of each land 67 adjacent each flute 64. To prevent excess friction between lands 61 and the wall of a hole being bored by bit 60, the outer cylindrical surface 69 of each land 67 is relieved radially inwards of lip 68 over most of the circumferential width of the land to form a thin margin or rib 70. The radially inwardly relieved land surface 71 thus formed is spaced inwards from the uncut outer cylindrical surface 72 of margin 70 at a distance referred to as rib clearance or body clearance. As is also shown in FIGS. 7 and 8, the two generally conically-shaped front end faces of lands 67 intersect at a dihedral angle which forms a chisel edge 73 at the vertex of tip 63. Body 61 of drill bit 60 is preferably back tapered to a slightly smaller diameter from tip to shank to further decrease friction between the drill body and a wall of a hole being drilled by the bit.

As shown in FIGS. 7 and 8, flutes 64, rather than being inclined at a constant rake or helix angle with respect to longitudinal center line 66 of drill bit body 61, are inclined at multiple angles. Thus, drill bit body 61 of a multiple rake twist drill bit 60 has a rear portion 61R in which flutes 64R are inclined at a conventional helix angle or rake α (Alpha) with respect to longitudinal axis 66, i.e., in the approximate range of 10 degrees to 45 degrees, with a preferred value of about 33 degrees, as shown in FIG. 7. The length of rear longitudinal portion 61R is not critical, but preferably is greater than about one-third the overall length of the fluted portion of drill bit body 61. As shown in FIGS. 7 and 8, body 61 of multiple rake twist drill bit 60 also has an intermediate longitudinal portion 61I in which flutes 64I are inclined at a smaller helix angle or rake β (Beta) with respect to longitudinal axis 66 of the body. According to the present invention, flutes 64I in the intermediate longitudinal portion 61I of drill bit body 61 are inclined at an angle of about 3 degrees to 15 degrees with respect to longitudinal axis 66, with a preferred value of about 7.5 degrees. Although the exact length of intermediate, low-rake fluted portion 61I of drill bit body 61 is not critical, that length should be at least greater than the diameter of the drill bit body, e.g., 0.030 to 0.050 inch for a drill bit having a diameter of 1/64 inch (0.015685 inch).

Referring still to FIGS. 7 and 8, it may be seen that body 61 of multiple rake twist drill bit 60 also has a front longitudinal portion 61F in which flutes 64F are inclined at a larger helix angle or rake [symbol] (Gamma) with respect to longitudinal axis 66 of the body. Flutes 64F are preferably inclined at an angle in the approximate range of 10 degrees to 45 degrees, with a preferred value of about 33 degrees with respect to longitudinal axis 66 of drill bit body 61. The length of front longitudinal portion 61F is not critical, but preferably is greater than about one-third the overall length of the fluted portion of drill bit body 61.

As shown in FIGS. 7 and 8 and described above, body 61 of multiple rake twist drill bit 60 has three different longitudinal portions, including an intermediate longitudinal portion 61I in which flutes 64I are inclined to longitudinal axis 66 of the drill bit body at a smaller rake or helix angle than front and rear portions 61F, 61R of the body. Flutes 64F, 64R are inclined at larger rakes or helix angles than flutes 641. Although this triple rake construction is somewhat more complex than the dual rake construction described previously, it has been found that triple rake bit bores somewhat cleaner holes than the dual rake bit. Tests have indicated that the wear rate of the triple rake bit is somewhat greater than that of the dual rake bit, but is still substantially less than the wear rate of prior art, single rake bits.

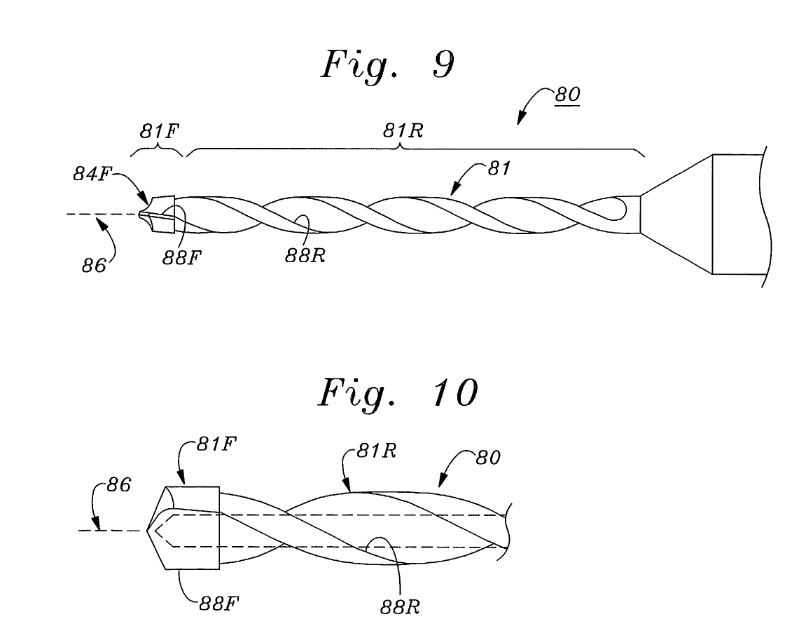

FIGS. 9 and 10 illustrate a third embodiment 80 of a multiple rake or helix angle twist drill bit according to the present invention.

As shown in FIGS. 9 and 10, embodiment 80 of a multiple rake drill bit has a longitudinal elongated body 81 in which is formed a plurality of helically spiraled grooves or flutes 84. Body 81 has a relatively short front longitudinal portion 81F, and a relatively longer rear longitudinal portion 81R. As shown in FIGS. 9 and 10, rear longitudinal portion 81R of body has a smaller diameter than front portion 81F, the outer cylindrical surface thereof being undercut radially inwardly of the front longitudinal portion. In a preferred embodiment of drill bit 80, flutes 84F in front portion 81F of the bit have cutting lips 88F that are inclined at a small rake or helix angle, with respect to longitudinal axis 86 of the bit.

The rake or helix angle of lips 88F is about 3 degrees to 15 degrees, with a preferred value of about 7.5 degrees. Although the exact length of front, low rake fluted portion 81F of drill bit body 81 is not critical, that length is preferably greater than the diameter of the drill bit body. In rear portion 81R of body 81, cutting lips 88R have a larger rake angle in the approximate range of 10 degrees to 45 degrees, with a preferred value of about 33 degrees.

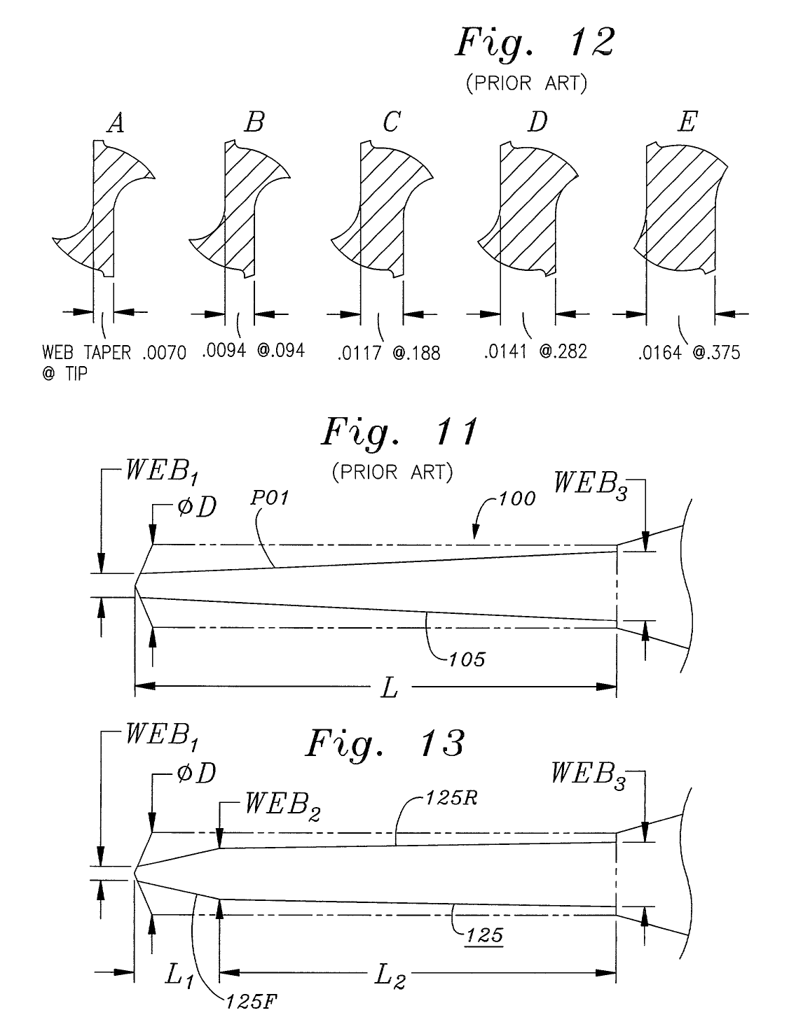

FIGS. 11 and 12 illustrate a prior art twist drill bit 100 in which the longitudinally disposed, uncut central web section 105 of the drill bit body 101 has a front tapered transverse cross section, i.e., tapers to a greater thickness from the tip of the drill rearward to the base or root of the body. The purpose of this increasing web thickness is to increase the rigidity of the bit to improve accuracy of holes drilled, and to strengthen the bit to increase its resistance to breaking. As shown in FIG. 10, the outer surface of drill bit body 101 is back tapered, to reduce friction between that surface and the wall of a hole being drilled, as has been discussed above. Multiple rake bits according to the present invention preferably have a tapered web.

FIG. 13 illustrates a modified twist drill bit 120, in which the web 125 thereof has multiple tapers. Thus, as shown in FIG. 13, web 125 has a front portion 125F which extends rearward a distance L1 from tip 123. Front web portion 125F has a relatively acute front taper, i.e., between about 0.085 inch per inch and 0.12 inch per inch with an average value of about 0.10 inch per inch, as compared to a typical prior art, single taper bit having a taper of about 0.015 to 0.025 inch per inch. Dual taper drill bit 120 also has a relatively long rear portion 125R which has a smaller taper. Since front portions of rear web portion 125R have a greater thickness than prior art drill bits having a single taper, multiple web-taper drill bit 120 has greater strength and rigidity than such prior art drill bits.

The present inventor has determined that suitable web dimensions and taper values for dual web taper drill bits according to the present invention preferably are varied as a function of drill bit diameter, in approximate accordance with to the following equations:

W₂=0.58D Eqn. 1

0.25D˜<W₁˜<0.40D Eqn. 2

D in the approximate size range of 0.004 inch to 0.020 inch

L₁=(W₂−W₁)/0.105 Eqn. 3

L₂=L−L₁ Eqn. 4

W₃=(L−L₁)×(0.008)+W₂ Eqn. 5

$$\begin{matrix}{T}_{S} = \frac{{W}_{3} - {W}_{1}}{L} & Eqn . 6 \\ {T}_{DR} = \frac{{W}_{3} - {W}_{2}}{{L}_{2}} & Eqn . 7 \\ {T}_{DF} = \frac{{W}_{2} - {W}_{1}}{{L}_{1}} & Eqn . 8\end{matrix}$$

Where D is the diameter of the drill bit.

W₁ is the front web thickness

W₂ is the intermediate web thickness

W₃ is the rear web thickness at the drill bit root

L is the length of the drill bit body

L₁ is the length of the front tapered portion of the drill bit

L₂ is the length of the rear tapered portion of the bit

Lₛ is the taper of a single taper bit

T_{DR} is the rear taper of a dual taper bit

T_{DF} is the front taper of a dual taper bit.

Table 1 lists web thicknesses and tapers for dual web taper drill bits of various diameters calculated from equations 1-5. For example, row 1 of table 1 indicates values for a 0.10 mm (0.04 inch) diameter bit, calculated as follows:

W₂=0.58D=0.58(0.004 inch)=0.00232 inch

W₁=0.40D=0.40(0.004 inch)=0.0016 inch

L₁=(W₂−W₁)/0.105=(0.0023−0.0016)0.105=0.0067 inch

L₂=(L−L₁)=(0.0400−00067)=0.0333 inch

W₃=(L₂)(0.008)+W₂=(0.0333 inch)(0.008)+0.00232 inch=0.002559 inch

Tₛ=(W₃−W₁)L=(0.0026−0.0016)/0.0400 inch=0.025 inch/inch

T_{DR}=(W₃−W₂)/L₂=(0.0026−0.0023)/0.0067=0.0091 inch/inch

T_{DF}=(W₂−W₁)/L₁=(0.0025−0.0016)/0.0067=0.105 inch/inch

In the foregoing example, it may be seen that a dual taper drill according to the present invention typically has a relatively long rear portion which has less taper than that of a single taper prior art bit, e.g., about one-half that of the prior art bit, and a relatively short front portion that has a substantially greater taper than that of single taper bit, e.g., about four times greater.

The strength increasing, dual taper construction described above is advantageously useable in single rake drill bits as well as multiple rake bits.

TABLE 1
Dual Web Taper Dimensions
W2 = .58*fD L1 = (W2 − W1)/.105 W3 = (L − L1)*(.008] + W2

| | | | | | | | Web |
|---|---|---|---|---|---|---|---|
| Drill | | | | | | | Thick- |
| Size | φΔ(Iv.) | Web 1 | Web 2 | Web 3 | L | L1 | ness % |
| .10 | 0.0040 | 0.0016 | 0.0023 | 0.0026 | 0.0400 | 0.0069 | 0.40 |
| mm | | | | | | | |
| .13 | 0.0050 | 0.0020 | 0.0029 | 0.0032 | 0.0500 | 0.0086 | 0.40 |
| mm | | | | | | | |
| .15 | 0.0059 | 0.0024 | 0.0034 | 0.0038 | 0.0600 | 0.0101 | 0.40 |
| mm | | | | | | | |
| #97 | 0.0059 | 0.0024 | 0.0034 | 0.0040 | 0.0800 | 0.0101 | 0.40 |
| #96 | 0.0063 | 0.0025 | 0.0037 | 0.0042 | 0.0800 | 0.0108 | 0.40 |
| #95 | 0.0067 | 0.0027 | 0.0039 | 0.0044 | 0.0800 | 0.0115 | 0.40 |
| #94 | 0.0071 | 0.0025 | 0.0041 | 0.0046 | 0.0800 | 0.0156 | 0.35 |
| #93 | 0.0075 | 0.0026 | 0.0044 | 0.0049 | 0.0800 | 0.0164 | 0.35 |
| #92 | 0.0079 | 0.0028 | 0.0046 | 0.0051 | 0.0800 | 0.0173 | 0.35 |
| .20 | 0.0079 | 0.0028 | 0.0046 | 0.0051 | 0.0800 | 0.0173 | 0.35 |
| mm | | | | | | | |
| #91 | 0.0083 | 0.0029 | 0.0048 | 0.0053 | 0.0800 | 0.0182 | 0.35 |
| #90 | 0.0087 | 0.0030 | 0.0050 | 0.0057 | 0.1000 | 0.0191 | 0.35 |
| #89 | 0.0091 | 0.0030 | 0.0053 | 0.0059 | 0.1000 | 0.0217 | 0.33 |
| #88 | 0.0095 | 0.0031 | 0.0055 | 0.0061 | 0.1000 | 0.0226 | 0.33 |
| .25 | 0.0098 | 0.0032 | 0.0057 | 0.0063 | 0.1000 | 0.0233 | 0.33 |
| mm | | | | | | | |
| #87 | 0.0100 | 0.0033 | 0.0058 | 0.0067 | 0.1400 | 0.0238 | 0.33 |
| #86 | 0.0105 | 0.0032 | 0.0061 | 0.0070 | 0.1400 | 0.0280 | 0.30 |
| #85 | 0.0110 | 0.0030 | 0.0064 | 0.0072 | 0.1400 | 0.0325 | 0.27 |
| #84 | 0.0115 | 0.0031 | 0.0067 | 0.0075 | 0.1400 | 0.0340 | 0.27 |
| .30 | 0.0118 | 0.0032 | 0.0068 | 0.0077 | 0.1400 | 0.0348 | 0.27 |
| mm | | | | | | | |
| #83 | 0.0120 | 0.0032 | 0.0070 | 0.0078 | 0.1400 | 0.0354 | 0.27 |
| #82 | 0.0125 | 0.0034 | 0.0073 | 0.0081 | 0.1400 | 0.0369 | 0.27 |
| #81 | 0.0130 | 0.0035 | 0.0075 | 0.0084 | 0.1400 | 0.0384 | 0.27 |
| #80 | 0.0135 | 0.0036 | 0.0078 | 0.0094 | 0.2400 | 0.0399 | 0.27 |
| .35 | 0.0138 | 0.0037 | 0.0080 | 0.0096 | 0.2400 | 0.0407 | 0.27 |
| mm | | | | | | | |
| #79 | 0.0145 | 0.0039 | 0.0084 | 0.0100 | 0.2400 | 0.0428 | 0.27 |
| 1/64 | 0.0156 | 0.0042 | 0.0090 | 0.0106 | 0.2400 | 0.0461 | 0.27 |
| .40 | 0.0158 | 0.0043 | 0.0092 | 0.0107 | 0.2400 | 0.0466 | 0.27 |
| mm | | | | | | | |
| #78 | 0.0160 | 0.0043 | 0.0093 | 0.0108 | 0.2400 | 0.0472 | 0.27 |
| .45 | 0.0177 | 0.0044 | 0.0103 | 0.0117 | 0.2400 | 0.0556 | 0.25 |
| mm | | | | | | | |
| #77 | 0.0180 | 0.0045 | 0.0104 | 0.0119 | 0.2400 | 0.0566 | 0.25 |
| .50 | 0.0197 | 0.0049 | 0.0114 | 0.0129 | 0.2400 | 0.0619 | 0.25 |
| mm | | | | | | | |
| #76 | 0.0200 | 0.0050 | 0.0116 | 0.0130 | 0.2400 | 0.0629 | 0.25 |

What is claimed is:

1. A twist drill bit comprising;
A. a shank adapted to be rotatably driven, and
b. a longitudinally elongated drill body which protrudes coaxially forward from said shank, said body having
(i) a tip which tapers forward to a point, and
(ii) at least a first flute formed in said body and disposed longitudinally rearwardly from said tip, said flute having a first longitudinal portion inclined at a first rake angle with respect to a longitudinal axis of said body, and a second longitudinal portion inclined at a second rake angle with respect to said longitudinal axis of said body, said body having formed therein adjacent to said flute a land having a longitudinally disposed cutting lip having a first longitudinal portion inclined at said first rake angle relative to said longitudinal axis of said body, and a second longitudinal portion inclined at said second rake angle relative to longitudinal axis of said body.

2. The twist drill bit of claim 1 wherein said first flute is helically spiraled around said longitudinal axis of said drill body.

3. The twist drill bit of claim 2 wherein said body has a circular transverse outline.

4. The twist drill bit of claim 3 further including a second flute.

5. The twist drill bit of claim 4 wherein said second flute is mirror symmetric through a longitudinally disposed center plane of said body with said first flute.

6. The twist drill bit of claim 4 wherein the length of said first longitudinal portion of said flutes is at least as great as the diameter of said drill bit body.

7. The twist drill bit of claim 6 wherein said first rake angle lies in the range of about 3 degrees to about 10 degrees.

8. The twist drill bit of claim 7 wherein said second rake angle lies in the range of about 15 degrees to about 45 degrees.

9. The twist drill bit of claim 6 wherein said first rake angle lies in a range of about 7.5 degrees, plus or minus 2.5 degrees.

10. The twist drill bit of claim 9 wherein said second rake angle lies in a range of about 33 degrees plus or minus 12 degrees.

11. The twist drill bit of claim 1 wherein said first longitudinal portion of said flute is adjacent to said tip of said body.

12. The twist drill bit of claim 11 wherein said second longitudinal portion is adjacent to said shank of said body.

13. The twist drill bit of claim 12 wherein said flute has a third longitudinal portion located between said first and second longitudinal portions and inclined at a third rake angle with respect to said longitudinal axis of said body.

14. The twist drill bit of claim 13 wherein said third rake angle is less than said first and second rake angles.

15. The twist drill bit of claim 14 wherein said first and second rake angles are equal.

16. The twist drill bit of claim 11 wherein said first longitudinal portion of said flute is formed in a first, front longitudinal portion of said body, said body having a second longitudinal portion rearward of said front longitudinal portion which has a smaller diameter than that of said front longitudinal portion of said body.

17. The twist drill bit of claim 1 wherein said body has a web which has at least two different tapers.

18. The twist drill bit of claim 17 wherein said web has a front portion rearward of said tip which has a first, acute forward taper and a rear portion which has a second, less acute taper.

19. The twist drill bit of claim 18 wherein said second taper is vanishingly small.

20. The twist drill bit of claim 19 wherein said body is back tapered.

21. A twist drill bit comprising;
a. a longitudinally disposed, generally cylindrically-shaped shank, said shank adapted to be insertably and coaxially received by a collet and rotated about a longitudinal axis of said shank, and
b. a longitudinally elongated, generally cylindrically-shaped drill body which protrudes coaxially forward from said shank, said body having formed therein,
(i) a generally conically-shaped tip, and
(ii) a pair of first and second flutes formed in circumferentially spaced apart locations in a cylindrical wall surface of said body, each of said flutes having a first longitudinal portion inclined at a first rake angle with respect to a longitudinal axis of said body, and a second longitudinal portion inclined at a second rake angle with respect to said longitudinal axis of said body, said body having formed therein adjacent to said flutes a pair of lands each having a longitudinally disposed cutting lip which has a first longitudinal portion inclined at said first rake angle relative to said longitudinal body axis, and a second longitudinal portion inclined at said second rake angle relative to said longitudinal axis of said body.

22. The twist drill bit of claim 21 wherein said first longitudinal portion of said flute is adjacent to said tip of said body.

23. The twist drill bit of claim 22 wherein said second longitudinal portion is adjacent to said shank of said body.

24. The twist drill bit of claim 23 wherein said flute has a third longitudinal portion located between said first and second longitudinal portions and inclined at a third rake angle with respect to said longitudinal axis of said body.

25. The twist drill bit of claim 24 wherein said third rake angle is less than said first and second rake angles.

26. The twist drill bit of claim 25 wherein said first and second rake angles are equal.

27. The twist drill bit of claim 21 wherein said first and second flutes are helically spiraled around said longitudinal axis of said drill body.

28. The twist drill bit of claim 27 wherein the length of said first longitudinal portion of said flutes inclined at said first rake angle relative to longitudinal axis of said body is at least as great as the diameter of said body.

29. The twist drill bit of claim 28 wherein said first rake angle lies in the range of about 3 degrees to about 10 degrees.

30. The twist drill bit of claim 29 wherein said second rake angle lies in the range of about 15 degrees to about 45 degrees.

31. The twist drill bit of claim 28 wherein said first rake angle lies in a range of about 7.5 degrees, plus or minus 2.5 degrees.

32. The twist drill bit of claim 29 wherein said second rake angle lies in a range of about 33 degrees plus or minus 12 degrees.

33. The twist drill of claim 28 wherein said drill body is back tapered.

34. In a twist drill bit having a cutting portion which includes a longitudinally elongated, generally cylindrically-shaped body having a tip which tapers to a smaller diameter, and at least a first longitudinally disposed flute formed in said body and forming on opposite circumferential sides of said flute a land, one longitudinal edge of which serves as a cutting edge or lip for cutting material from an article to form therein a hole when said tip is pressed against a surface of said article and said bit is rotated about a longitudinal axis of said body in a direction from said cutting edge towards said flute, the improvement comprising;
said cutting edge having a first longitudinal portion inclined at a first, small rake angle with respect to said longitudinal axis of said body, and a second longitudinal portion inclined at a second, larger rake angle with respect to said longitudinal axis.

35. The improved twist drill bit of claim 34 wherein said first flute has first and second portions angled with respect to said longitudinal axis of said body at said same respective angles as said first and second portions of said cutting edge.

36. The improved twist drill bit of claim 34 wherein said first flute is helically spiraled around said longitudinal axis of said body.

37. The improved twist drill bit of claim 36 further including a second flute having circumferentially adjacent thereto a second land in which is formed a second cutting edge.

38. The improved twist drill bit of claim 37 wherein said second flute is helically spiraled around said longitudinal axis of said body.

39. The improved twist drill bit of claim 38 wherein at least a portion of the outer circumferential surface of each of said lands is relieved radially inwards of said cutting edges.

40. The improved twist drill bit of claim 34 wherein said first longitudinal portion of said flute is adjacent to said tip of said body.

41. The improved twist drill bit of claim 40 wherein said second longitudinal portion is adjacent to said shank of said body.

42. The improved twist drill bit of claim 41 wherein said flute has a third longitudinal portion located between said first and second longitudinal portions and inclined at a third rake angle with respect to said longitudinal axis of said body.

43. The improved twist drill bit of claim 42 wherein said third rake angle is less than said first and second rake angles.

44. The improved twist drill bit of claim 43 wherein said first and second rake angles are equal.

45. The improved twist drill bit of claim 40 wherein said first longitudinal portion of said flute is formed in a first, front longitudinal portion of said body, said body having a second longitudinal portion rearward of said front longitudinal portion which has a smaller diameter than that of said front longitudinal portion.

46. The improved twist drill bit of claim 34 wherein said body has a web which has at least two different tapers.

47. The twist drill bit of claim 46 wherein said web has a front portion rearward of said tip which has a first, acute forward taper and a rear portion which has a second, less acute taper.

48. The twist drill bit of claim 47 wherein said second taper is vanishingly small.

49. The twist drill bot of claim 48 wherein said body is back tapered.

50. In a twist drill bit having a cutting portion which includes a longitudinally elongated, generally cylindrically-shaped body having a tip which tapers to a smaller diameter, and at least a first longitudinally disposed flute formed in said body and forming on opposite circumferential sides of said flute a land, one longitudinal edge of which serves as a cutting edge or lip for cutting material from an article to form therein a hole when said tip is pressed against a surface of said article and said bit is rotated about a longitudinal axis of said body in a direction from said cutting edge towards said flute, the improvement comprising;
a web having at least two different tapers.

51. The twist drill bit of claim 50 wherein said web has a front portion rearward of said tip which has a first, acute forward taper and a rear portion which has a second, less acute taper.

52. The twist drill bit of claim 51 wherein said second taper is vanishingly small.

53. The twist drill bit of claim 52 wherein said body is back tapered.

54. In a twist drill bit, the improvement comprising a central longitudinally disposed web having at least first and second longitudinal portions having first and second tapers, respectively.

55. The twist drill bit of claim 54 wherein said first longitudinal portion of said drill bit having said first taper is a front longitudinal portion of said bit and said second longitudinal portion of said bit having second taper is a rear longitudinal portion of said bit.

56. The twist drill bit of claim 55 wherein said first front longitudinal portion of said web has a taper of approximately 0.100 inch per inch, plus or minus about 0.02 inch per inch.

57. The twist drill bit of claim 56 wherein said second, rear longitudinal portion of said web has a taper of approximately 0.01 inch per inch plus or minus about 0.002 inch per inch.

58. The twist drill bit of claim 57 wherein front longitudinal portion of said drill bit has a length of about 22 percent plus or minus about 8 percent of the length of the body of said drill bit, measured between the shank and tip thereof.
